(19) United States
(12) Patent Application Publication
(10) Pub. No.: US 2020/0015000 A1
(43) Pub. Date: Jan. 9, 2020

(54) EARPHONE

(71) Applicant: Audio-Technica Corporation, Tokyo (JP)

(72) Inventors: Nonomi SHIWAKU, Tokyo (JP); Daisuke YONEYAMA, Tokyo (JP)

(21) Appl. No.: 16/459,746

(22) Filed: Jul. 2, 2019

(30) Foreign Application Priority Data
Jul. 4, 2018 (JP) 2018-127474
Jun. 27, 2019 (JP) 2019-119248

(51) Int. Cl. H04R 1/28; H04R 1/10; H04R 1/02

(52) U.S. Cl. CPC H04R 1/2849; H04R 1/02; H04R 1/1016

(57) ABSTRACT

The present invention provides an earphone having an improved balance between sound waves in a low-frequency range and in a high-frequency range. The earphone according to the present invention includes a diaphragm, and a sound emission surface that is spaced away from a front surface of the diaphragm. The sound emission surface includes a sound passing hole and a vent hole that sound waves generated by vibration of the diaphragm pass through. The sound emission surface is bulbous or dome shaped with a peripheral edge extending to a top part. The sound passing hole is disposed closer to the peripheral edge of the sound emission surface as compared to the vent hole. The vent hole is disposed closer to the top part of the sound emission surface as compared to the sound passing hole.

### TECHNICAL FIELD

The present invention relates to an earphone.

### BACKGROUND ART

Earphones have various shapes so as to match the preference of a user in, for example, acoustic characteristics, and fashionability.

The shape of an inner ear type (also referred to as an open type) is one of typical shapes of earphones. The inner ear type earphone has a shape that a housing for storing a diaphragm is worn inside the auricle of a user's ear. Sound waves from the diaphragm are emitted from a plurality of sound passing holes toward the ear canal of the user's ear. The plurality of sound passing holes are disposed on a sound emission surface facing the diaphragm.

The diffraction angle of sound wave is smaller as the wavelength of the sound wave is shorter. Therefore, sound waves in a high-frequency range among the sound waves from the diaphragm have high straightness. On the other hand, sound waves in a low-frequency range among the sound waves from the diaphragm have high diffusibility. Thus, in the inner ear type earphone, the sound waves in the high-frequency range after passing through the sound passing holes hardly cause loss, and easily reach the eardrum of the user. On the other hand, the sound waves in the low-frequency range after passing through the sound passing holes easily cause loss, and hardly reach the eardrum of the user. In this manner, the inner ear type earphone has an acoustic characteristic that the sound waves in a high-frequency range is more easily emphasized than the sound waves in a low-frequency range.

A canal-type earphone is an earphone that improves such acoustic characteristic of the inner ear type. The canal-type earphone includes a housing accommodating a diaphragm, a sound guiding tube extending from the housing, and an earpiece disposed on the tip side of the sound guiding tube. Sound waves from the diaphragm are emitted through the sound guiding tube toward the ear canal of a user's ear. Then the ear canal is completely blocked since the earpiece of the canal-type earphone is worn inside the ear canal of the user's ear. Thus, the canal-type earphone is not favored by people who sense oppression of ears.

Conventionally, an earphone, which attains improvement of a balance between sound waves in a low-frequency range and a high-frequency range has been proposed (for example, see U.S. Pat. No. 8,971,561). The earphone is emphasizing the sound waves in the low-frequency range by deforming the shape of the inner ear type earphone that the sound waves in the high-frequency range is more easily emphasized than the sound waves in the low-frequency range.

### SUMMARY OF INVENTION

### Technical Problem

However, in the proposed earphone, sound waves from a diaphragm disposed within a housing are guided to a direction, which is different from a vibration direction of the diaphragm, by an inner wall of the housing, and are emitted from a sound passing hole of the housing. That is, the proposed earphone has a shape that the sound waves from the diaphragm are blocked by the housing. As a result, the proposed earphone causes loss of the sound waves in the high-frequency range having high straightness.

An object of the present invention is to solve the problem described above and to provide an earphone with an acoustic characteristic of having an improved balance between sound waves in a low-frequency range and a high-frequency range.

### Solution to Problem

The earphone according to the present invention includes a diaphragm, and a sound emission surface that is spaced away from a front surface of the diaphragm. The sound emission surface includes a sound passing hole and a vent hole that sound waves generated by vibration of the diaphragm pass through. The sound emission surface is bulbous or dome shaped with a peripheral edge extending to a top part. The sound passing hole is disposed closer to the peripheral edge of the sound emission surface as compared to the vent hole. The vent hole is disposed closer to the top part of the sound emission surface as compared to the sound passing hole.

### Advantageous Effects of Invention

According to the present invention, an earphone having an improved balance between sound waves in a low-frequency range and a high-frequency range can be provided.

### BRIEF DESCRIPTION OF DRAWINGS

FIG. 1 is a figure illustrating an embodiment of an earphone according to the present invention, and is a perspective view of a right unit constituting the earphone.

FIG. 2 is a front view of the right unit.

FIG. 3 is a left side view of the right unit.

FIG. 4 is a right side view of the right unit.

FIG. 5 is a cross-sectional view of the right unit taken along line A-A in FIG. 2.

FIG. 6 is an acoustic equivalent circuit diagram of the right unit.

FIG. 7 is a graph illustrating an acoustic characteristic of the earphone.

### DESCRIPTION OF EMBODIMENTS

Embodiments of an earphone according to the present invention will now be described referring to the attached drawings.

The earphone outputs sound waves (voice) in accordance with an audio signal (electrical signal) from a sound source such as a portable music player (not illustrated) to an eardrum of a user of the earphone. The earphone includes a right unit to be worn on the right ear of the user, and a left unit to be worn on the left ear of the user.

The configuration of the left unit is the same as the configuration of the right unit, except that these two are bilaterally symmetrical. Thus, the earphone according to the present invention will now be described by using the right unit as an example.

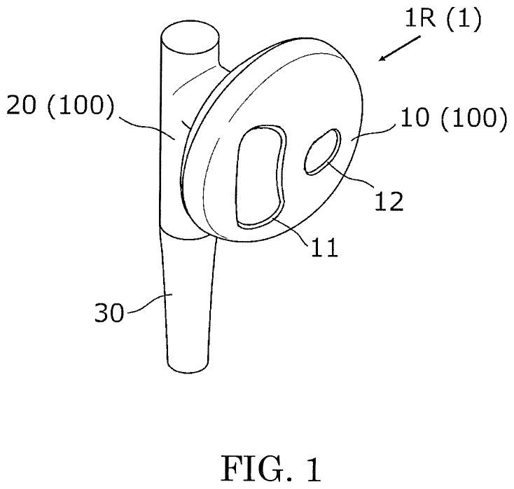

FIG. 1 is a figure illustrating an embodiment of an earphone according to the present invention, and is a perspective view of a right unit 1R of an earphone 1.

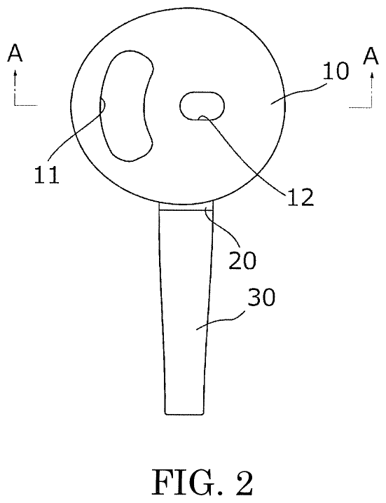

FIG. 2 is a front view of the right unit 1R.

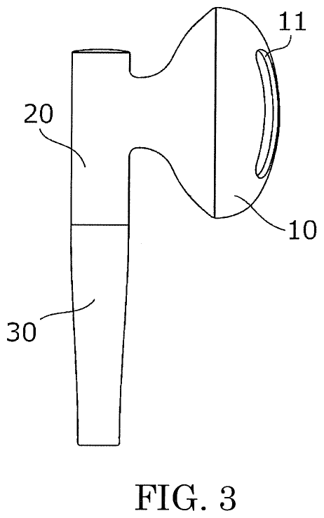

FIG. 3 is a left side view of the right unit 1R.

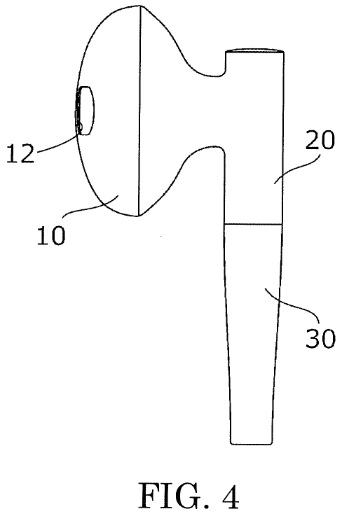

FIG. 4 is a right side view of the right unit 1R.

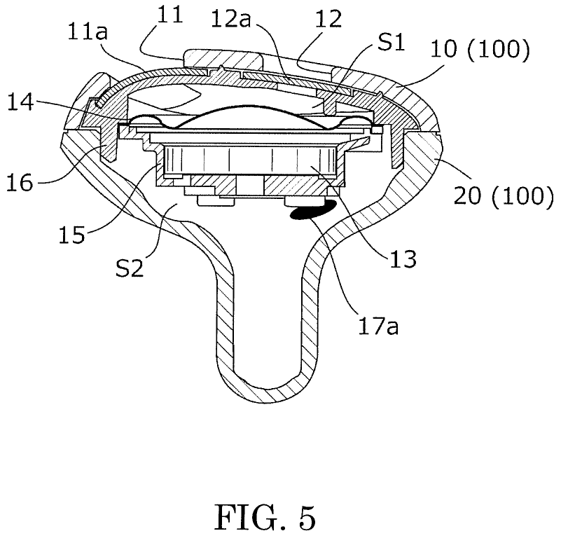

FIG. 5 is a cross-sectional view of the right unit 1R taken along line A-A in FIG. 2.

The right unit 1R includes a front housing 10, a rear housing 20, a cord bush 30, a sound passing hole 11, a vent hole 12, an electroacoustic transducer (described later), a sound passing hole adjusting member 11a, a vent hole adjusting member 12a, and a rear hole adjusting member 17a. The front housing 10 and the rear housing 20 constitute a housing 100.

The housing 100 stores the electroacoustic transducer. The electroacoustic transducer outputs sound waves in accordance with an audio signal from a music player. The housing 100 is constituted by joining the front housing 10 and the rear housing 20. The inside of the housing 100 is hollow. The material of the housing 100 is, for example, synthetic resin.

The cord bush 30 prevents, for example, disconnection due to bending of a signal line. The inside of the cord bush 30 is hollow. The signal line inputs the audio signal from the music player to the electroacoustic transducer. The signal line is inserted through the cord bush 30. A space inside the cord bush 30 communicates with a rear space S2 (see FIG. 5) within the rear housing 20. The material of the cord bush 30 is, for example, silicon.

One end of the signal line is connected to the electroacoustic transducer. The other end of the signal line is, for example, connected to the music player if the earphone 1 is a wire type, or connected to a receiving circuit (not illustrated) that wirelessly receives an audio signal from the music player if the earphone 1 is a wireless type.

It should be noted that, in order to improve wearability on a user's ear, for example, the earphone according to the present invention may be configured such that a part of the housing 100 contacting the ear is covered with a cover made of silicon. In this regard, the cover includes holes that are disposed at positions overlapping with the sound passing hole 11 and the vent hole 12. Therefore, when this cover is disposed to cover the surface of the front housing 10, the sound passing hole 11 and the vent hole 12 provided with the front housing 10 are not blocked by the cover. The sound passing hole 11 and the vent hole 12 will be described later.

The front housing 10 is an output surface (sound emission surface) of the sound waves output from the electroacoustic transducer. The front housing 10 is disposed on a front side of a vibration direction of a diaphragm 14 (see FIG. 5) constituting the electroacoustic transducer. More specifically, the front housing 10 (the sound emission surface) is spaced away from a front surface of the diaphragm 14. The front housing 10 includes the sound passing hole 11 and the vent hole 12. The sound passing hole 11 and the vent hole 12 are disposed on the front housing 10 (sound emission surface). The sound waves output from the electroacoustic transducer will be output (emitted) from the sound passing hole 11 and the venting vent hole 12. More specifically, the sound waves output from the electroacoustic transducer is partially output from the right unit 1R without being blocked by the front housing 10. Thus, among the sound waves output from the electroacoustic transducer, sound waves in the high-frequency range hardly cause loss.

As illustrated in FIG. 3 and FIG. 4, in a side view, the shape of the front housing 10 is convex, i.e., a dome shape, toward the front side (the right side in FIG. 3 and the left side in FIG. 4) of the vibration direction of the diaphragm 14.

On the front housing 10, the sound passing hole 11 is disposed on the left side in FIG. 2. On the other hand, on the front housing 10, the vent hole 12 is disposed closer to the right side in FIG. 2 as compared to the sound passing hole 11. More specifically, as illustrated in FIG. 5, the sound passing hole 11 is disposed over one end (the left side in FIG. 5) of the diaphragm 14 (the sound passing hole 11 is disposed over one side of the diaphragm 14) stored within the housing 100, and the vent hole 12 is disposed over another end (the right side in FIG. 5) of the diaphragm 14 (the vent hole 12 is disposed over another side of the diaphragm 14). That is, as illustrated in FIG. 2 and FIG. 5, the sound passing hole 11 is disposed closer to a peripheral edge of the front housing 10 as compared to the vent hole 12. On the other hand, the vent hole 12 is disposed closer to a top part of the front housing 10 as compared to the sound passing hole 11.

As illustrated in FIG. 2, the shape of the front housing 10 is convex to the side where the sound passing hole 11 is disposed (the left side in the figure). In other words, the front housing 10 (the sound emission surface) is bulbous or dome shaped with the peripheral edge extending to the top part. More specifically, in a front view, the length from the central point of a virtual perfect circle having the length of the front housing 10 in the height direction (the vertical direction in the figure) as its diameter, to the edge on the side where the sound passing hole 11 is disposed, is longer than the length from this central point to the edge on the side where the vent hole 12 is disposed (the right side in the figure).

When the right unit 1R is worn on the user's ear, all or a part of the sound passing hole 11 is disposed inside the ear canal, and the vent hole 12 is disposed outside the ear canal. More specifically, when the right unit 1R is worn on the user's ear, the sound passing hole 11 is disposed at a position closer to the ear canal (eardrum) as compared to the vent hole 12, and the vent hole 12 is disposed at a position more distant from the ear canal (eardrum) as compared to the sound passing hole 11.

The shape of the sound passing hole 11 is different from the shape of the vent hole 12.

As illustrated in FIG. 2, an area of the sound passing hole 11 is larger than an area of the vent hole 12.

The sound passing hole 11 is a hole that is long in the vertical direction in FIG. 2. On the other hand, the vent hole 12 is a hole that is long in the horizontal direction in FIG. 2. That is, the longitudinal direction of the sound passing hole 11 is different from the longitudinal direction of the vent hole 12.

It should be noted that, in the present invention, the shape and the number of the vent hole are optional. More specifically, for example, the longitudinal direction of the vent hole may be the same as longitudinal direction of the sound passing hole. In addition, there may be a plurality of the vent holes. However, even when there is such a plurality of the vent holes, the area of the sound passing hole is larger than the total area of the vent holes.

The shape of the sound passing hole 11 is convex to the peripheral edge side (the left side in FIG. 2) of the front housing 10.

The difference in the shapes and the sizes, or the difference in the arrangement positions on the front housing 10 between the sound passing hole 11 and the vent hole 12, which has been described above, affects an acoustic characteristic of the right unit 1R as will be described later. More specifically, the acoustic characteristic of the right unit 1R is determined in accordance with the shapes and the like of the sound passing hole 11 and of the vent hole 12. That is to say, the shapes and the like of the sound passing hole 11 and of the vent hole 12 are set in consideration of the acoustic characteristic of the right unit 1R. In addition, as the details will be described later, permeability of the sound passing hole adjusting member 11a, of the vent hole adjusting member 12a, and of the rear hole adjusting member 17a also affects the acoustic characteristic of the right unit 1R.

The electroacoustic transducer includes a driver unit 13 and the diaphragm 14.

The driver unit 13 vibrates the diaphragm 14 in accordance with the audio signal input from the signal line. The driver unit 13 is fixed within the housing 100 by a support 15. The electroacoustic transducer is protected from external force applied to the front housing 10, by a protector 16 disposed inside the front housing 10.

The diaphragm 14 generates the sound waves by vibration in accordance with the audio signal input from the signal line. The diaphragm 14 is disposed to face the front housing 10. The material of the diaphragm 14 is, for example, synthetic resin. The diaphragm 14 is a circular plate. The diaphragm 14 includes a dome-shaped center dome and a sub dome having an arc-shaped cross section. In diaphragm 14, the center dome is disposed on the center, and the sub dome surrounds the outer periphery of the center dome.

The space inside the housing 100 is partitioned into two spaces by the driver unit 13. One of the spaces is a “front space S1” which is partitioned by the front housing 10 and the driver unit 13. The other space is a “rear space S2” which is partitioned by the rear housing 20 and the driver unit 13. The front space S1 communicates with the exterior of the right unit 1R through the sound passing hole 11 and the vent hole 12. The rear space S2 communicates with the exterior of the right unit 1R through a rear hole (not illustrated) disposed in the rear housing 20.

The sound waves generated by the vibration of the diaphragm 14 pass through the sound passing hole 11 after passing through the sound passing hole adjusting member 11a. Similarly, the sound waves generated by the vibration of the diaphragm 14 pass through the vent hole 12 after passing through the vent hole adjusting member 12a. The sound waves output from the front housing 10 (sound emission surface) are composed of the sound waves having passed through the sound passing hole 11 and the vent hole 12.

The material of the sound passing hole adjusting member 11a is, for example, nylon mesh. The sound passing hole adjusting member 11a covers the entire sound passing hole 11 from the inside of the housing 100. In other words, the sound passing hole adjusting member 11a is disposed on the sound passing hole 11.

The material of the vent hole adjusting member 12a is, for example, nylon mesh. The vent hole adjusting member 12a covers the entire vent hole 12 from the inside of the housing 100. In other words, the vent hole adjusting member 12a is disposed on the vent hole 12.

The rear hole disposed on the rear housing 20 is covered with the rear hole adjusting member 17a. The material of the rear hole adjusting member 17a is, for example, nylon mesh. The rear hole adjusting member 17a covers the entire rear hole from the inside of the housing 100. In other words, the rear hole adjusting member 17a is disposed on the rear hole.

The permeability of the sound passing hole adjusting member 11a, of the vent hole adjusting member 12a, and of the rear hole adjusting member 17a affects the acoustic characteristic of the sound waves output from the front housing 10. That is, such permeability affects the sound waves output from the right unit 1R. More specifically, the acoustic characteristic of the sound waves output from the right unit 1R is set in accordance with the permeability of the sound passing hole adjusting member 11a, of the vent hole adjusting member 12a, and of the rear hole adjusting member 17a. In other words, the permeability of the sound passing hole adjusting member 11a, of the vent hole adjusting member 12a, and of the rear hole adjusting member 17a is set such that the acoustic characteristic of the sound waves output from the right unit 1R becomes a desired characteristic. The permeability of the sound passing hole adjusting member 11a, of the vent hole adjusting member 12a, and of the rear hole adjusting member 17a is, for example, different from one another.

It should be noted that the materials of the sound passing hole adjusting member, the vent hole adjusting member, and the rear hole adjusting member may be, for example, non-woven fabrics such as cotton and resin. In addition, the material of the sound passing hole adjusting member, of the vent hole adjusting member, and of the rear hole adjusting member may be, for example, different from one another.

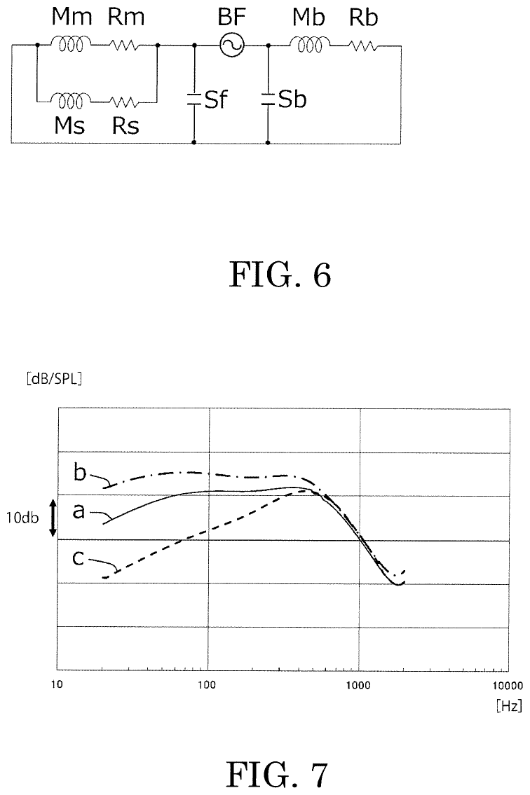

FIG. 6 is an acoustic equivalent circuit diagram of the right unit 1R. Each of the reference signs in the figure is as follows.

BF: sound pressure of the diaphragm 14

Mm: acoustic mass of air within the sound passing hole 11

Rm: acoustic resistance of air within the sound passing hole 11

Ms: acoustic mass of air within the vent hole 12

Rs: acoustic resistance of air within the vent hole 12

Mb: acoustic mass of air within the rear hole

Rb: acoustic resistance of air within the rear hole

Sf: stiffness of the front space

Sb: stiffness of the rear space

In the equivalent circuit diagram of the right unit 1R, the material and the permeability of the sound passing hole adjusting member 11a, and of the vent hole adjusting member 12a are set such that the following relational expression is satisfied.

Rm<Rs

FIG. 7 is a graph illustrating frequency characteristics that are examples of the acoustic characteristic of the right unit 1R (earphone 1). In the figure, the horizontal axis indicates frequency, and the vertical axis indicates sound pressure.

In this figure, (a) indicates the frequency characteristic of the right unit 1R, (b) indicates the frequency characteristic of the right unit 1R with the vent hole 12 closed, and (c) indicates the frequency characteristic of a conventional inner ear type earphone with a plurality of sound passing holes disposed on a sound emission surface facing a diaphragm.

In this figure, (a) and (c) indicate that the sound pressure of (a) is larger than the sound pressure of (c) in a low-frequency range (about 500 Hz or lower). More specifically, FIG. 7 indicates that the right unit 1R improves the acoustic characteristic of the conventional inner ear type earphone that the sound waves in the high-frequency range is more easily emphasized than the sound waves in the low-frequency range.

In this figure, (a) and (b) indicate that the sound pressure of (a) is smaller than the sound pressure of (b) in the low-frequency range (about 500 Hz or lower). More specifically, FIG. 7 indicates that the vent hole 12 of the right unit 1R takes a role of reducing the sound pressure of the low-frequency range.

In the earphone according to the embodiment described above, the right unit 1R includes the front housing 10 (sound emission surface) which is disposed to face the diaphragm 14. The sound waves generated by the vibration of the diaphragm 14 pass through the sound passing hole 11 and the vent hole 12. The sound passing hole 11 and the vent hole 12 are disposed in the front housing 10. In this regard, the vent hole 12 adjusts the acoustic characteristic of the sound waves output from the sound emission surface, i.e., the sound waves output from the right unit 1R. In addition, in the right unit 1R, the sound passing hole 11 is disposed in the inner side (eardrum side) of the ear canal of the user as compared to the vent hole 12. That is to say, the sound waves output from the sound passing hole 11 more easily reach the eardrum than the sound waves output from the vent hole 12.

Thus, in the right unit 1R, the size and the shape of the vent hole 12 with respect to the sound passing hole 11, or the material, the permeability, and the like of the vent hole adjusting member 12a with respect to the sound passing hole adjusting member 11a are, for example, set such that the aforementioned relational expression, “Rm<Rs”, is satisfied, thereby adjusting the acoustic characteristic of the sound waves reaching the eardrum of the user. That is to say, the balance between the sound waves in the low-frequency range and the high-frequency range of the earphone 1 is adjusted by setting the shape, the material, the permeability, and the like of the vent hole 12 and of the vent hole adjusting member 12a with respect to the shape, the material, the permeability, and the like of the sound passing hole 11 and of the sound passing hole adjusting member 11a.

Moreover, the sound passing hole 11 and the vent hole 12 are both disposed on the front side of the vibration direction of the diaphragm 14. More specifically, the arrangement direction of the sound passing hole 11 to the vibration direction of the diaphragm 14 is the same as the arrangement direction of the vent hole 12 to the vibration direction of the diaphragm 14. In particular, the sound passing hole 11 which is disposed at a position close to the eardrum of the user is disposed on the front side of the vibration direction of the diaphragm 14. Therefore, the sound waves from the diaphragm 14 are less likely to be blocked by the housing 100. More specifically, loss of the sound waves in the high-frequency range output from the right unit 1R is small. That is to say, the earphone 1 can avoid loss of the sound waves in the high-frequency range as is the case of the conventional inner ear type earphone, and can improve the acoustic characteristic of the conventional inner ear type earphone that the sound waves in the high-frequency range is more easily emphasized than the sound waves in the low-frequency range. In other words, the earphone 1 realizes an acoustic characteristic similar to an acoustic characteristic of the canal-type earphone without completely blocking the ear canal as is the case of the canal-type earphone.

In the earphone according to the embodiment described above, the right unit 1R includes one vent hole 12 with respect to one sound passing hole 11, on the sound emission surface. Alternatively, the earphone according to the present invention may be configured to include a plurality of vent holes with respect to one sound passing hole, on the sound emission surface. Even in the case of such configuration, an earphone having an improved balance between sound waves in a low-frequency range and a high-frequency range can also be obtained by setting the shape, the material, the permeability, and the like of all the vent holes with respect to the shape, the material, the permeability, and the like of the sound passing hole and of the sound passing hole adjusting member. In this regard, the arrangement positions of the respective vent holes on the sound emission surface may be, for example, at the same distance from the sound passing hole or at different distances from the sound passing hole.

1. An earphone comprising:
a diaphragm; and
a sound emission surface that is spaced away from a front surface of the diaphragm, wherein
the sound emission surface comprises a sound passing hole and a vent hole that sound waves generated by vibration of the diaphragm pass through,
the sound emission surface is bulbous or dome shaped with a peripheral edge extending to a top part,
the sound passing hole is disposed closer to the peripheral edge of the sound emission surface as compared to the vent hole, and
the vent hole is disposed closer to the top part of the sound emission surface as compared to the sound passing hole.

2. The earphone according to claim 1, wherein when the earphone is worn on a user's ear, the sound passing hole is disposed at a position closer to an eardrum of the user as compared to the vent hole.

3. The earphone according to claim 1, wherein the shape of the sound emission surface is convex to a side where the sound passing hole is disposed.

4. The earphone according to claim 1, wherein
the sound passing hole is disposed over one side of the diaphragm on the sound emission surface, and
the vent hole is disposed over another side of the diaphragm on the sound emission surface.

5. The earphone according to claim 1, wherein a shape of the sound passing hole is convex to a peripheral edge side of the sound emission surface.

6. The earphone according to claim 1, wherein the shape of the sound passing hole is different from a shape of the vent hole.

7. The earphone according to claim 1, wherein an area of the sound passing hole is larger than an area of the vent hole.

8. The earphone according to claim 1, wherein the vent hole adjusts an acoustic characteristic of the sound waves output from the sound emission surface.

9. The earphone according to claim 1, comprising:
a sound passing hole adjusting member that is disposed to cover the sound passing hole; and
a vent hole adjusting member that is disposed to cover the vent hole, wherein permeability of the sound passing hole adjusting member is different from permeability of the vent hole adjusting member.
